(19) United States
(12) Patent Application Publication
(10) Pub. No.: US 2023/0339183 A1
(43) Pub. Date: Oct. 26, 2023

(54) VOLUMETRIC BUILDER SYSTEMS AND METHODS FOR BUILDING SAND CASTING MOLDS, CORES, AND TEMPORARY TOOLS

(71) Applicant: LightSpeed Concepts Inc., Albion, MI (US)

(72) Inventors: Michael L. Powell, Horton, MI (US); Thomas J. Wilson, Jackson, MI (US); Jacob Sponsler, Whitmore Lake, MI (US); Brandon Welker, Wixom, MI (US); John P. Biel, Ann Arbor, MI (US); Daniel G. Shirkey, Spring Arbor, MI (US); John R. Keough, Ann Arbor, MI (US); Thomas A. Cobett, Strongsville, OH (US); Elmer Lee, Canton, MI (US)

(73) Assignee: LightSpeed Concepts Inc., Albion, MI (US)

(21) Appl. No.: 18/304,716

(22) Filed: Apr. 21, 2023

Related U.S. Application Data
(60) Provisional application No. 63/333,290, filed on Apr. 21, 2022.

(51) Int. Cl. B29C 64/329; B29C 64/165; B29C 64/209; B29C 64/295; B29C 64/245; B29C 64/218; B29C 64/343; B29C 64/35

(52) U.S. Cl. CPC B29C 64/329; B29C 64/165; B29C 64/209; B29C 64/295; B29C 64/245; B29C 64/218; B29C 64/343; B29C 64/35; B33Y 30/00

(57) ABSTRACT

A volumetric builder machine for enhanced fabrication of sand-casting molds, cores and/or 3-dimensional shapes in printed layers within a build box. A bi-directional layer builder assembly passes back-and-forth over the build box, and with each pass deposits an even layer of loose sand while printing a water-based binder agent according to a pattern representing the mold and/or core to be formed. Heater banks carried on the traveling layer builder assembly accelerate the binder drying module process. The build box has a build plate that is incrementally lowered by a lift unit to accommodate each new sand layer. A strategic heating system preheats the sand, heats the build plate, and directs heat to the sand layer after it has been printed with binder. A ventilation system removes vapors driven from the binder. A sand filling station periodically refills the layer builder assembly. A cleaning station removes binder residue from the printheads.

### CROSS REFERENCE TO RELATED APPLICATIONS

This application claims priority to Provisional Patent Application U.S. 63/333,290 filed on Apr. 21, 2022, the entire disclosure of which is hereby incorporated by reference and relied upon.

### BACKGROUND OF THE INVENTION

Field of the Invention. The present invention relates generally to systems and methods for building sand-casting molds, cores, and temporary tools, and more particularly to systems and methods for the additive manufacture of sand-casting molds, cores and/or 3-dimensional shapes.

Description of Related Art Sand-casting is a metal casting process that uses sand as the mold material. Molds made of sand have the advantage of being inexpensive and able to withstand the high temperatures required for foundry use. So that the loose sand can maintain a desired shape, a suitable bonding agent is mixed with or applied to the sand. One example of a suitable bonding agent is described in US Patent Publication No. 2021/0370388, published Dec. 2, 2021, in the name of LightSpeed Concepts Inc. The entire disclosure of US2021/0370388 is hereby incorporated by reference and relied upon.

The sand-casting process typically includes the steps of: 1) Placing a pattern, which includes a gating system, in a build box or flask and then packing sand around the pattern, to create a mold; 2) removing the pattern to create a mold cavity in the mold; 3) filling the mold cavity with molten metal and then allowing the metal to cool; and finally 4) removing the cast metal part and gating system from the sand mold. Most sand molds are broken into pieces to remove the casting, and therefore the molds cannot be re-used without reconditioning and reforming the sand.

The initial step of placing a pattern in a build box or flask to create a mold has certain limitations. For one, there is a possibility that the sand mixture may not adequately fill the spaces around the pattern, resulting in unwanted voids in the mold. To alleviate this, the mold assembly is sometimes vibrated prior to removing the pattern. However, there always remains a risk of unwanted voids, and the vibration step introduces additional concerns.

Another shortcoming is the requirement to design patterns and gating systems with draft angles. Because the patterns and gating systems must be removed from the sand in the build box, tapered sides, or draft angles, are typically designed into these pattern shapes. Such draft angles may not be required from an engineering standpoint in the final cast part yet are included solely to facilitate removal of the pattern from the sand.

Yet another shortcoming is the inability to form truly complex metal casting shapes. Because the pattern must be removed from the sand in the build box or flask, there are inherent limitations in the complexity of shapes that can be produced. To achieve moderately complex shapes, the mold designer must resort to a variety of techniques, which may include tortuous manipulation of the mold parting line, the use of mold cores, multi-piece moldings, and the like. In many cases, the cast metal part must be subjected to extensive post-machining processes. To achieve certain complex shapes, it may also be necessary to utilize some other type of more expensive manufacturing process, such as investment casting, lost wax/foam casting, sintering, and so forth.

Moreover, there is a desire in the metal casting industry to improve the accuracy of the cast metal part, and thereby limit the effort required to bring a metal casting into design specification by grinding, welding, and the like.

Furthermore, there is a desire in the metal casting industry to automate the process of making sand molds for production line use. There is a long-felt need in the art for systems and methods for making or building sand-casting molds and cores that are reliable and accurate, that can produce cast metal parts without draft angles, in complex shapes with minimal post-production attention, and that can be automated for production line applications.

So-called volumetric builder systems and methods for making casting molds, cores, and temporary tools have recently emerged to quickly and accurately produce cast metal parts. Generally stated, volumetric builder systems operate on the principles of 3D printing technology. For example, U.S. Patent Publication No. 2016/0193651 discloses 3D Printed metal-casting molds in which an untreated sand is used as the build material and a polymer is used as a component of the binder that is printed onto the build material. Other examples include U.S. Pat. Nos. 8,951,033 and 10,507,592.

Such volumetric builder systems and methods for making sand molds are in the relative infancy of their development and adaptation for commercial use. The field of making sand molds has many unique characteristics which have made commercial applications of 3D printing technology particularly challenging. There is therefore a need in the art for improvements that will enable commercial implementation of 3D printed systems and methods for making or building sand-casting molds, cores and/or 3-dimensional shapes.

### BRIEF SUMMARY OF THE INVENTION

According to one aspect of the invention, a machine is provided for making sand-casting molds, cores and/or 3-dimensional shapes in bi-directionally printed layers. The machine includes a primary guide track that extends longitudinally between opposite ends. One end of the primary guide track is designated as a build end. A build box is supported on the primary guide track for shuttling movement toward and away from the build end. The build box has sidewalls that form an interior space. The interior space defines a bottom and an open top for the build box. A horizontal build plate is disposed inside of the sidewalls of the build box and is configured for vertical movement between the open top and the bottom. A lift unit is configured to vertically displace the build plate up and down within the sidewalls. A secondary track extends parallel to, and longitudinally overlaps, the primary guide track. A length of the secondary track is designated as a print section. The print section overlies the build end of the primary guide track. A bi-directional layer builder assembly is supported on the secondary track for back-and-forth movement within the print section. The layer builder assembly includes a printer module. The printer module has a forward face and a longitudinally spaced rearward face. The printer module includes a printer array that is configured to print a binder agent on sand according to a predetermined pattern representing the mold and/or core to be formed. The layer builder assembly also has a forward sand dispensing nozzle and a rearward sand dispensing nozzle. The forward sand dispensing nozzle is longitudinally spaced from the forward face of the printer module, whereas the rearward sand dispensing nozzle is longitudinally spaced from the rearward face of the printer module. A forward sand leveler is disposed between the forward sand dispensing nozzle and the printer module. A rearward sand leveler is disposed between the rearward sand dispensing nozzle and the printer module. A forward heater bank is longitudinally spaced from the forward sand dispensing nozzle. A rearward heater bank is longitudinally spaced from the rearward sand dispensing nozzle.

According to another aspect of the invention, a method is provided for making sand-casting molds, cores and/or 3-dimensional shapes in bi-directionally printed layers. A build box is shuttled on a primary guide track toward and away from a station where custom sand cast m molds, cores and/or 3-dimensional shapes are formed in built-up layers. A horizontal build plate in the build box is incrementally lowered prior to the overpass of a bi-directional layer builder assembly that deposits an even layer of loose sand. The layer builder assembly includes a printer array configured to print binder agent onto the sand layer according to a predetermined pattern representing the mold and/or core to be formed. Heater banks carried on the traveling layer builder assembly initiate and/or advance the binder drying module process.

The bi-directional nature of the layer builder assembly enables rapid, high-precision formation of custom sand-casting molds and cores and other temporary objects of the type used in connection with metal casting.

### BRIEF DESCRIPTION OF THE SEVERAL VIEWS OF THE DRAWINGS

These and other features and advantages of the present invention will become more readily appreciated when considered in connection with the following detailed description and appended drawings, wherein:

FIG. 1 is a perspective view of a volumetric builder machine, according to an embodiment of the present invention;

FIG. 2 is a side elevation of the machine of FIG. 1;

FIG. 3 is a side view of a lift unit, according to an embodiment of the present invention;

FIG. 4 is a cross-sectional view of the lift unit taken generally along lines 4-4 in FIG. 3;

FIG. 5 is a top view of a build box according to an embodiment of the invention;

FIG. 6 is a side view of the build box of FIG. 5;

FIG. 7 is a cross-sectional view of the build box taken generally along lines 7-7 in FIG. 5;

FIG. 8 is an enlarged view of the area circumscribed at 8 in FIG. 7;

FIG. 9 is a first perspective view of a bi-directional layer builder assembly, according to an embodiment of the invention;

FIG. 10 is a second perspective view of the bi-directional layer builder assembly of FIG. 9;

FIG. 11 is a bottom view of the bi-directional layer builder assembly;

FIG. 12 is an end view of the bi-directional layer builder assembly;

FIG. 13 is a side view of the bi-directional layer builder assembly taken generally along lines 13-13 of FIG. 12;

FIG. 14 is a cross-sectional view of the bi-directional layer builder assembly taken generally along lines 14-14 of FIG. 12;

FIGS. 15A and 15B are highly simplified views showing a portion of the bi-directional layer builder assembly moving in forward and rearward directions over a build plate;

FIG. 16 is an end view of the mobile hopper and heater bank portions of a bi-directional layer builder assembly;

FIG. 17 is a side view of the mobile hopper and heater bank portions taken generally along lines 17-17 of FIG. 16;

FIG. 18 is a cross-sectional view of the mobile hopper and heater bank portions taken generally along lines 18-18 of FIG. 16;

FIG. 19 is an enlarged view of the area circumscribed at 19 in FIG. 18 showing a sand valve;

FIG. 20 is a side elevation view of a sand filling station according to an embodiment of the invention;

FIG. 21 is an end elevation of the sand filling station of FIG. 20;

FIG. 22 is a cross-sectional view taken generally along lines 22-22 of FIG. 20;

FIG. 23 is an enlarged view of the area circumscribed at 23 in FIG. 22 showing the bifurcated chute and its control valve;

FIG. 24 is a perspective view of a cleaning station according to an embodiment of the invention;

FIG. 25 is a side elevation view of the cleaning station of FIG. 24; and

FIG. 26 is a cross-sectional view taken generally along lines 26-26 of FIG. 25.

### DETAILED DESCRIPTION OF THE INVENTION

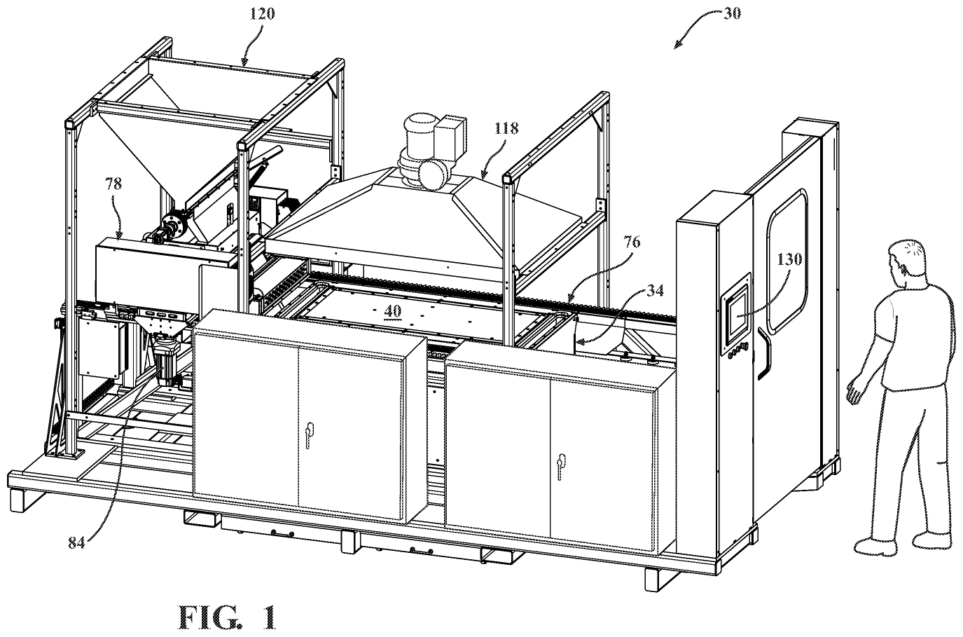

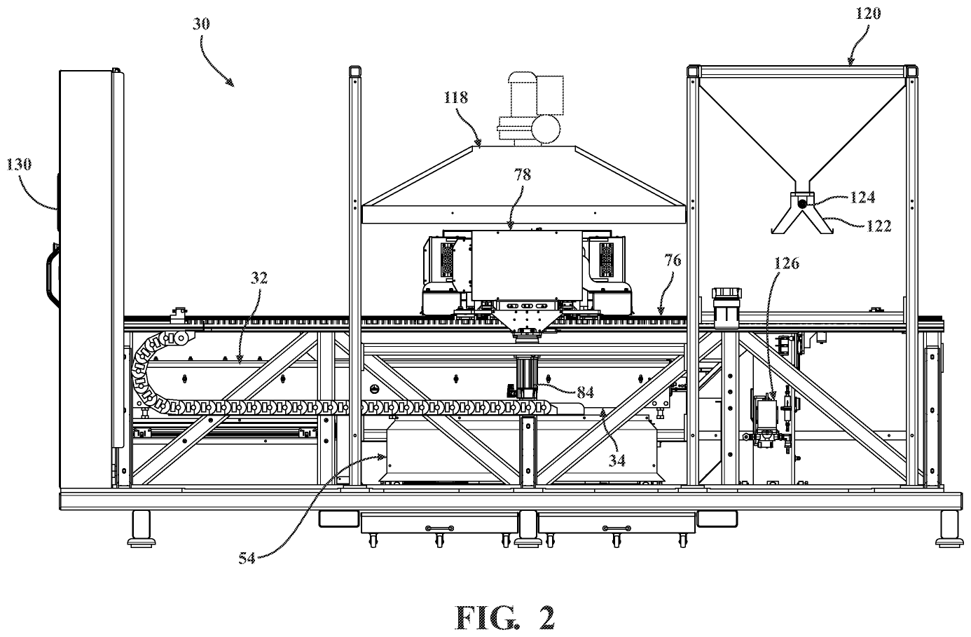

Referring to the figures, wherein like numerals indicate like or corresponding parts throughout the several views, a volumetric builder machine for making sand-casting molds, cores and/or 3-dimensional shapes in bi-directionally printed layers is generally shown at 30. The machine 30 is structured around a primary guide track 32 that extends longitudinally between opposite ends. The longitudinal direction of the machine 30 corresponds to a print/build direction as will be described in detail. One end of the primary guide track 32 comprises a load end whereas the other end comprises a build end. In FIG. 1, the load end is toward the right. In FIG. 2, the load end is toward the left, In both figures, the build end appears in about the center of the machine. As will be explained, the load end is used for both loading into and unloading from the machine 30.

The primary guide track 32 can be any suitable device or construction useful to establish a predetermined path of movement. In the illustrated examples, the primary guide track 32 takes the form of a pair of spaced-apart rails. Running surfaces of the rails may have an inverted “V” shape, as is common in some material handling applications. Although the “V” form is mentioned, those of skill in the art will appreciate that the rails could be configured in any form of track or guided path regardless of shape, including but not limited to round rails, square tubing, C-channels, L-tracks, slotted guides, guide wires, belts, chains, and such. In short, the primary guide track 32 is any device or construct that forms a constrained path of travel between the load and build ends.

A build box, generally indicated at 34, is supported on the primary guide track 32 for shuttling movement between the load and build ends. That is to say, the purpose of the constrained path of travel established by the primary guide track 32 is to control back-and-forth movement of the build box 34. The width of the build box 34 generally corresponds to the lateral spacing of the primary guide track 32, such that the build box 34 approximately spans the distance therebetween.

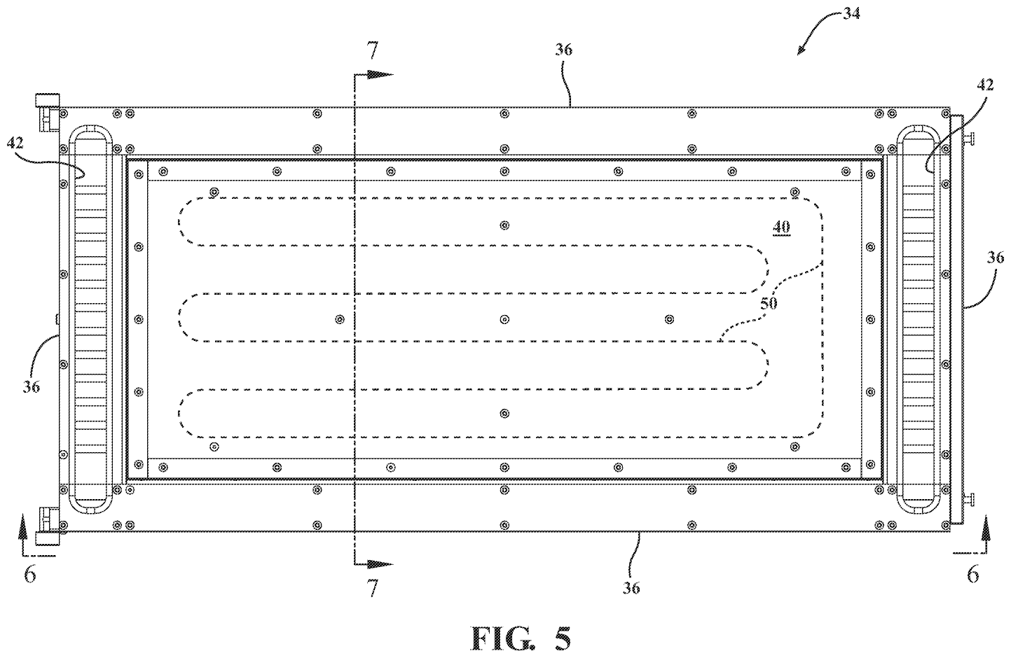

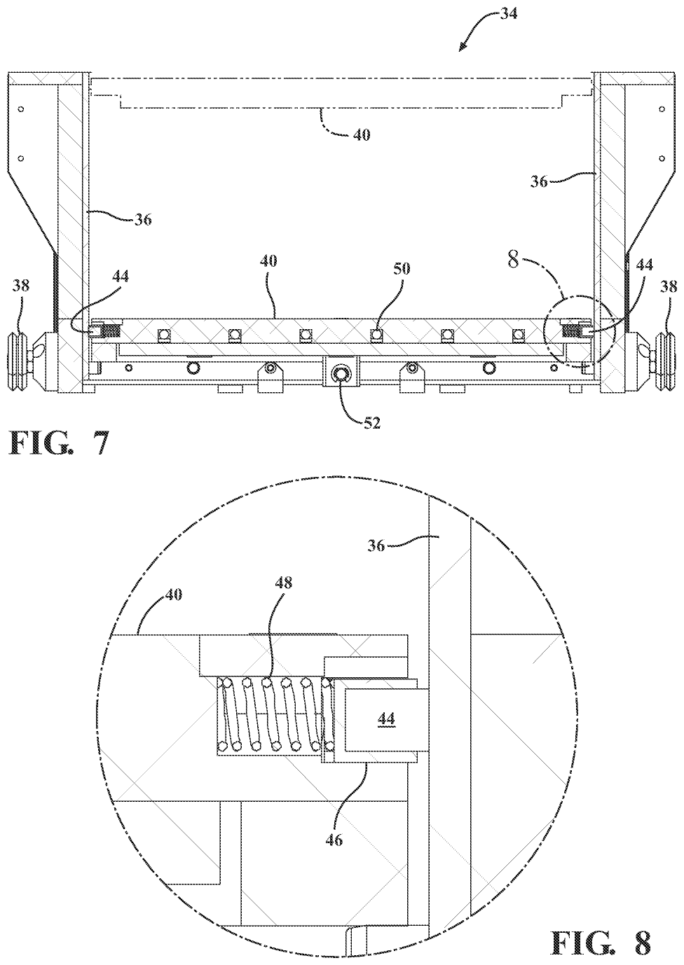

The build box 34 is perhaps best shown in FIGS. 5-8 having sidewalls 36 forming a generally interior space. The sidewalls 36 form the sides and ends of the build box 34. The build box 34 is preferably, although not necessarily, depicted in the form of a rectangular construct having the sidewalls 36 upstanding. The sidewalls 36 may be designed in any suitable fashion. The cross-section of FIG. 7 illustrates the walls may be built up from a sturdy metal liner clad with a mineral wool insulating panel. The upper edges of the longitudinally-extending sidewalls 36 may be provided with a substantial lip or flange to establish an upper rim of the build box 34. As best shown in the top view of FIG. 5, the rim of each end of the sidewalls 36 may include an overflow chamber 42 in which excess strike-off sand is captured. Struck-off sand captured in the overflow chambers can be reclaimed.

In the illustrated examples, the shape defined by the sidewalls 36 is generally rectangular when viewed from above, and by extension the interior space bounded by the sidewalls 36 is also generally rectangular in top view. In side elevations, the build box 34 can be seen having a bottom and an open top. That is, access to the interior space of the build box 34 is through an open top.

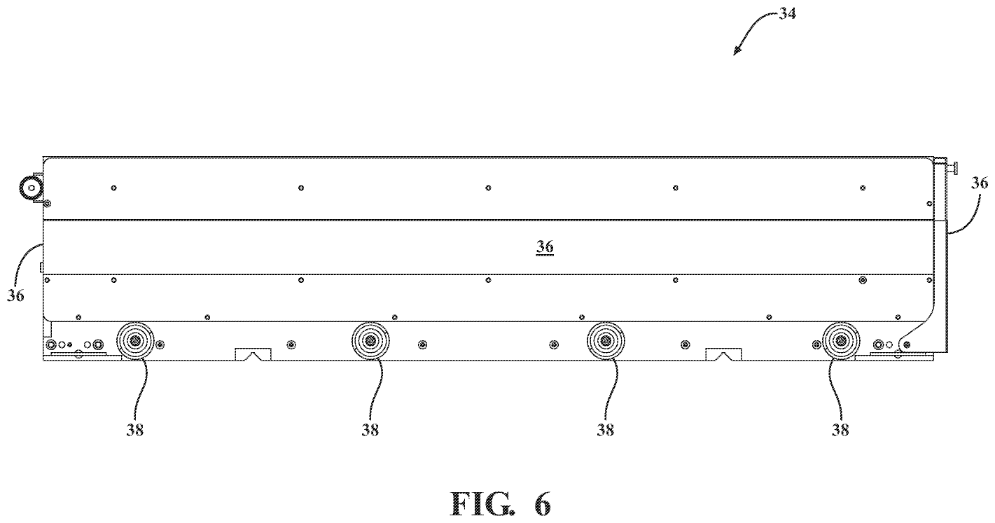

The build box 34 is configured to operatively engage the primary guide track 32. This could be through any design suited to the primary guide track 32. In cases where the primary guide track 32 includes rails, the build box 34 could be fitted with sliding blocks or wheels to ride on the rails. In the illustrated examples, the build box 34 includes wheels 38 adapted to engage the rails of the primary guide track 32. The wheels 38 may be arranged in sets along opposing sidewalls 36, as seen in FIG. 6. The wheels 38 are here shown spaced along the lower edges of the two longitudinally extending sidewalls 36 to provide stable rolling support for the build box 34. In FIG. 7, the wheels 38 are shown having V-grooves configured to rest on inverted “V” running surfaces of the rails. The wheels 38 would, of course, be configured to suit the primary guide track 32 and thereby enable rolling travel of the build box 34 between its load end and the longitudinally spaced build end, like a shuttle.

The build box 34 includes a horizontal build plate 40 disposed for vertical movement between the open top and the bottom. The build plate 40 is fully inset and designed to move up and down inside the confines of the straight vertical walls 36 like a piston. To accommodate the effects of thermal expansion, the build plate 40 is adequately undersized so as to establish a generous running clearance or gap between its peripheral edges and the inner surfaces of the walls 36. A dynamic perimeter seal around the build plate 40 bridges the gap and perfects a sand-tight seal at the interface with the interior surfaces of the sidewalls 36. The dynamic perimeter seal is best shown in FIGS. 7 and 8.

The dynamic perimeter seal can take any number of different configurations. In the illustrated examples, the dynamic perimeter seal includes a flexible element 44 disposed in a rigid carrier 46. The flexible element 44 can be a felt seal fitted in the carrier 46 with a portion standing proud to extend a cantilevered engaging surface that wipes against the inner surfaces of the sidewalls 36 thus providing a running seal thereagainst as the build plate 40 moves up and down inside the build box 34. The carrier 46 rides in an elongated pocket or slot formed in the peripheral edge of the build plate 40. The cartridge-like carrier 46 slides in and out like a retractable blade. For ease of manufacturing, it may be desirable to form the pocket by milling a step or rabbet around the peripheral edge, and then subsequently covering the rabbet with a retaining plate.

One or more biasing elements 48, appearing in FIG. 8 in the exemplary form of a compression spring, are embedded in the pocket so as to continually urge the carrier 46 outwardly. The springs 48 press against the rigid carrier 46 and consequently urge the flexible element 44 into engagement with the vertical sidewalls 36. Alternative types of biasing elements are contemplated, including but not limited to leaf and wire springs, pneumatic tubes, resilient piping, and the like.

Thus, in the preferred embodiment, sealing the perimeter of the build plate 40 to the interior sidewalls 36 of the build box 34 is accomplished using flexible wiper elements 44 mounted in carriers 46 that are spring loaded to provide seal pressure and accommodate thermal expansion. In this manner, the build plate 40 can be understood as a floating member inside the build box 34. FIG. 7 shows the build plate 40 in solid lines located near the bottom of the sidewalls 36, and in phantom lines near the open top of the sidewalls 36. Throughout this range of motion, the dynamic perimeter seal maintains engagement with the sidewalls 36 via the retractable felt element 44.

FIGS. 5 and 7 show that the build plate 40 may be configured to include at least one heating element 50. The heating element(s) 50 may be integrated into the body of the build plate 40 to protect from direct exposure to sand and contact with other parts of the machine 30 and/or workers. The heating element(s) 50 may be of any suitable type. Those depicted are of the electric resistance type arranged in a serpentine pattern to provide generally uniform heating across the full expanse of the build plate 40.

The underside of the build plate 40 may be fitted with one or more latches 52 as shown in FIG. 7. The latch 52 is configured to interact with a gripper feature of the lift unit, as will be described presently.

A lift unit, generally indicated at 54, is disposed below the build end of the primary guide track 32. The lift unit 54 may be centered below the primary guide track 32, adjacent to the build end. The lift unit 54 interacts with the build plate 40 only when the build box 34 is stationed at the build end of the primary guide track 32. The purpose of the lift unit 54 is to progressively lower the build plate 40 inside of the build box 34 as the sand mold is built-up in layers. During the build process in which the sand mold and/or core is formed in thin layers inside the build box 34, the lift unit 54 progressively lowers the build plate 40 according to a process that will be described in detail.

The lift unit 54 has a base plate 56 that is intended to be fixed, at least temporarily, relative to the primary guide track 32. In the preferred embodiment, the lift unit 54 takes the form of a scissor lift mechanism. In this context, the base plate 56 carries a fixed journal 58 and a traveling journal 60. The traveling journal 60 may be bedded in linear guides to enable sliding movement of the traveling journal 60 toward and away from the fixed journal 58 as the lift unit 54 raises and lowers in operation.

The lift unit 54 includes a table 62 moveable vertically relative to the base plate 56. In one embodiment, the table 62 is maintained parallel to the base plate 56 as it moves up and down through the mentioned scissor mechanism in which the table 62 carries a fixed journal 64 directly opposite the fixed journal 58 of the base plate 56, and a traveling journal 66 directly opposite the traveling journal 60 of the base plate 56. A first link 68, or pair of first links 68, pivotally connects the fixed journal 58 of the base plate 56 with the traveling journal 66 of the table 62. A second link 70, or pair of second links 70, pivotally connects the traveling journal 60 of the base plate 56 with the fixed journal 64 of the table 62. The intersecting midpoints of the links 68, 70 are pinned together at a center pivot, thus creating a manageable mechanism of four-bar linkages that enable the table 62 to raise and lower in a controlled manner. The table 62, in turn, is configured to engage the underside of the build plate 40 of the build box 34 and provide the motive force needed to raise and lower the build plate 40 inside the walls 36.

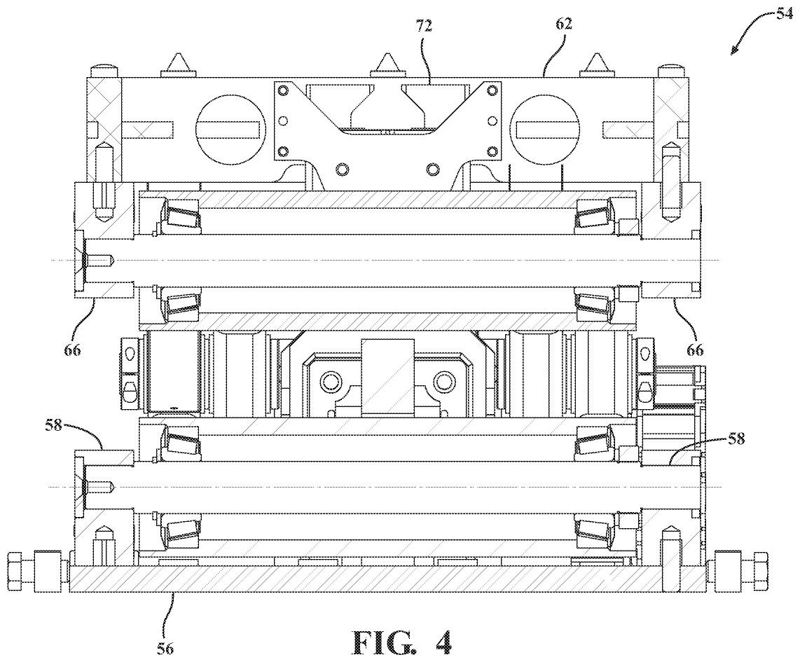

FIG. 4 is a cross section taken through the fixed journals 58, 64. In this example, each fixed journal 58, 64 carries an axle that is supported by tapered roller bearings. Each pair of tapered roller bearings are set against respective shoulders inside a sleeve, such that the sleeve is enabled to freely rock about its respective axle in a concentric manner. The first 68 and second 70 links are joined to the respective sleeves. The use of tapered roller bearings at the fixed pivot points (journals 58, 64) and linear guides for the traveling pivot points (journals 60, 66) enables the axial loading necessary to accomplish extreme rigidity and precision.

The table 62 may include a gripper 72, visible in FIG. 4, to engage the latch 52 located on the underside of the build plate 40. The purpose of the gripper 72 is to positively couple the build plate 40 to the table 62 so that two move in unison when the lift unit 54 is in descent. The accurate formation of a sand mold according to the teaching of this invention requires that the table 62 lower a precise distance at the start of each new sand layer build. Considering the frictional interfaces created by the dynamic perimeter seal, combined with the differing effects of thermal expansion, gravity alone cannot be trusted to lower the build plate 40 in concert with the lift unit 54. The gripper 72 may be actuated by any suitable means, including by a servo motor, to provide positive retention with the table 62. At the conclusion of a mold build, the gripper 72 is manipulated to release the latch 52 so that the build box 34 with finished mold can be transferred to the load station of the machine 30.

The lift unit 54 includes some type of actuator operatively disposed between the base plate 56 and the table 62 for raising and lowering the table 62 in a controlled manner. In one contemplated arrangement, the actuator comprises a jack screw operatively associated with one of the traveling journals 60, 66, or one of the other moving elements in the lift unit 54. Rotation of the jack screw causes the table 62 to raise and lower. For example, one part of the jack screw can be fixed to the base plate 56 while another part interacts with the traveling journal 60, pushing and pulling the traveling journal 60 to actuate the linkages. Those of skill in the art will envision other suitable connection points, as well as other types of actuators suitable to provide accurate motion control to the table 62.

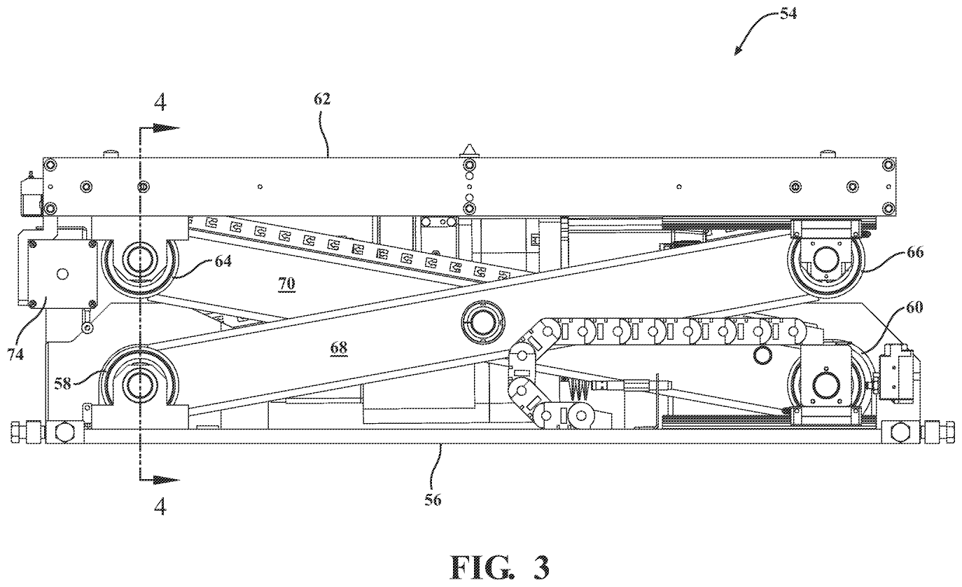

Preferably, the lift unit 54 is fitted with a system to accurately determine the elevation of the build plate 40 in real (or near real) time. Those of skill in the art will readily appreciate various types of monitoring systems and strategies suitable for use in the context of this present invention. In one example, a draw wire encoder 74 (FIG. 3) is attached to the table 62. The encoder 74 interacts with a draw wire (not shown) fixed in some manner relative to the base plate 56. The draw wire encoder 74 provides linear position feedback for the vertical stroke of the lift unit 54.

A secondary track 76 extends parallel to, and longitudinally overlaps, the primary guide track 32. The secondary track 76 is parallel to the primary guide track 32 but may be located at an elevation above the primary guide track 32, and/or located outside of (i.e., flank) the primary guide track 32. The secondary track 76 can take any suitable form, including but not limited to round rails, square tubing, C-channels, L-tracks, V-runners, slotted guides, guide wires, belts, chains, and such. The secondary track 76 may include at least one longitudinally extending rack gear. FIG. 1 shows an example where both sides of the secondary track 76 are configured with rack gears.

A length of the secondary track 76 that overlaps the build end of the primary guide track 32 comprises a print section. The secondary track 76 also has a service section. The service section is that portion of the secondary track 76 that extends longitudinally away from the print section and, in most cases, does not overlap the primary guide track 32. In FIG. 1, the print section is in the center and the service section is toward the left. In FIG. 2, the service section is toward the right and the print section is in the center.

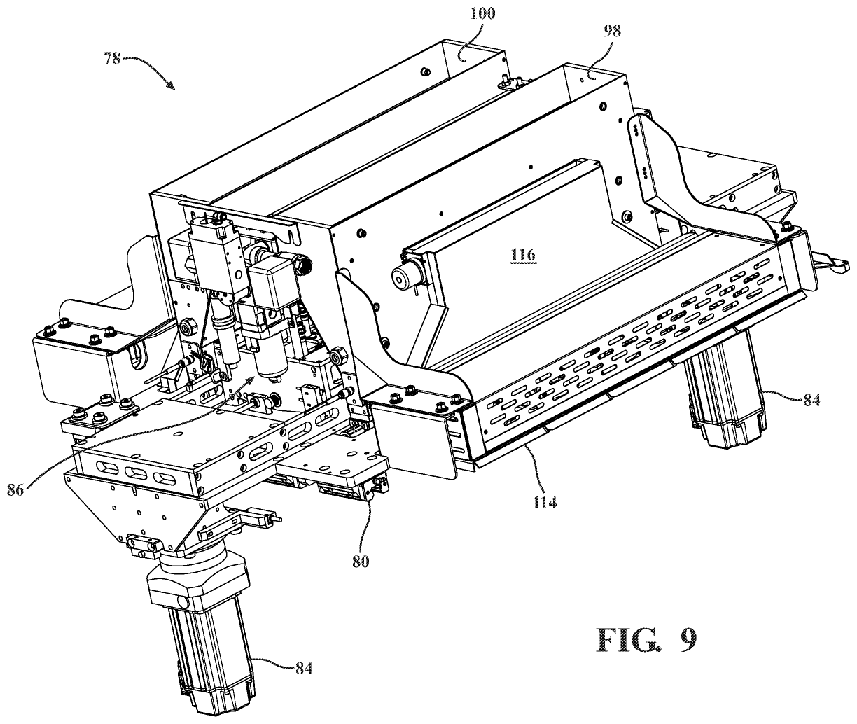

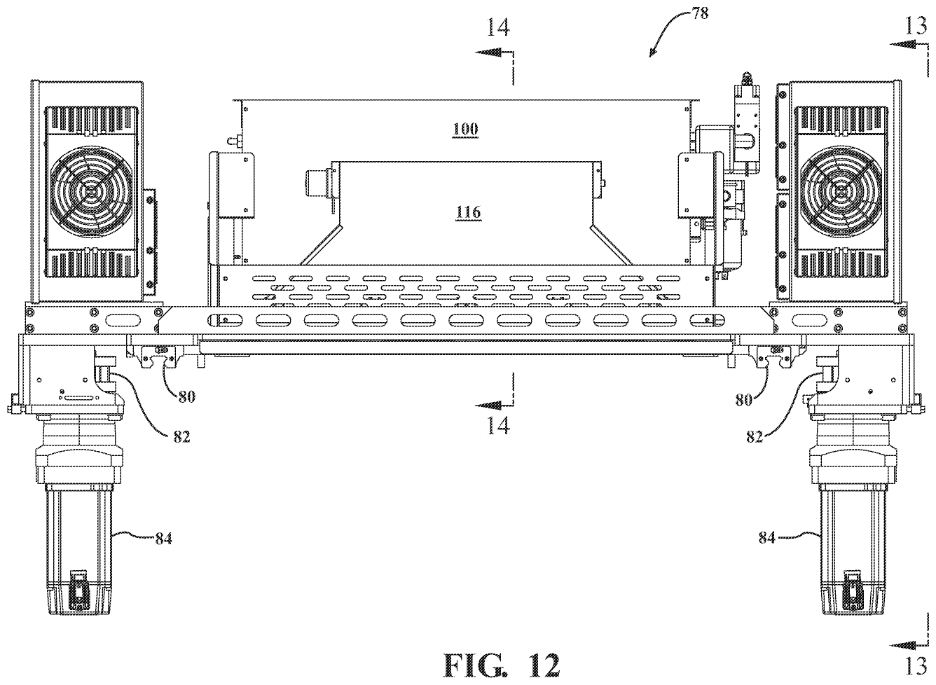

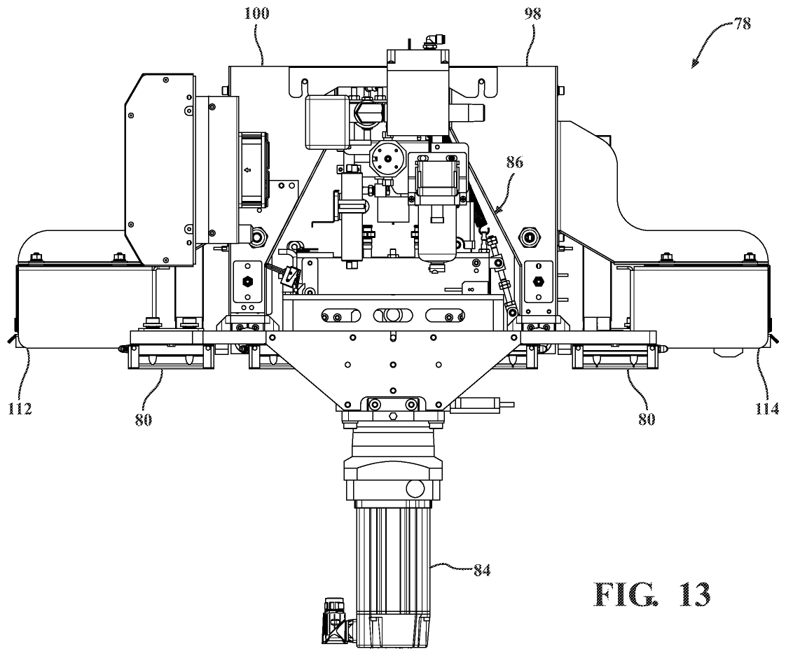

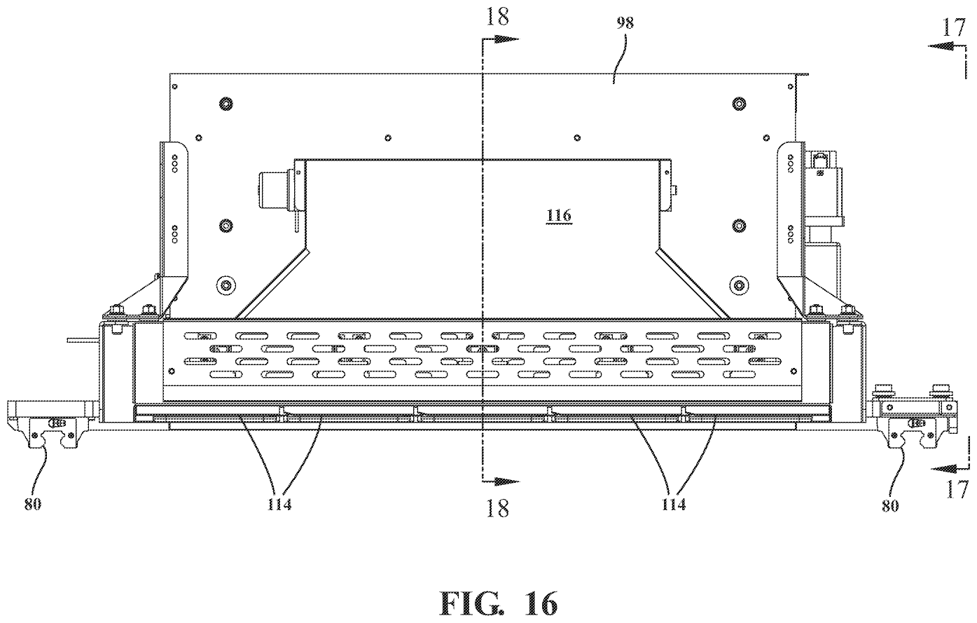

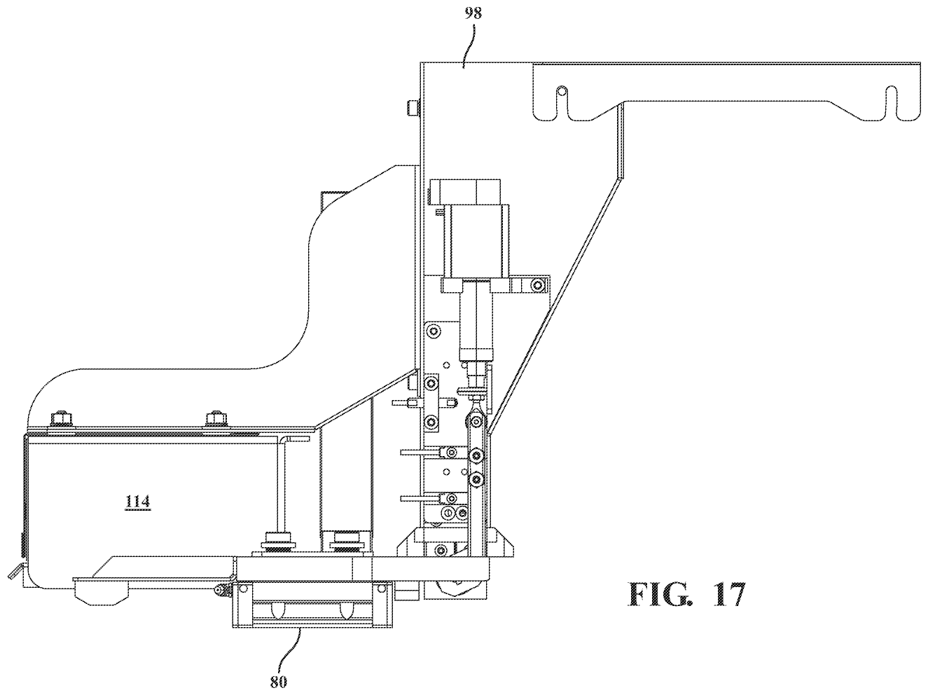

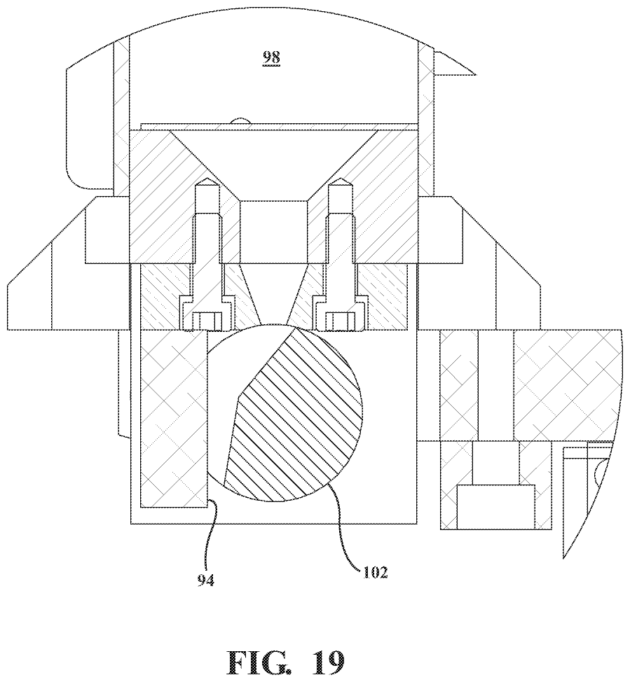

A bi-directional layer builder assembly is generally indicated at 78 in FIGS. 1, 2 and 9-19. The layer builder assembly 78 is supported on the secondary track 76 for back-and-forth movement between the print section and the service section. In this way, the layer builder assembly 78 is configured to shuttle, like a gantry, in forward and rearward longitudinal directions over a build box 34 stationed at the build end of the primary guide track 32. The layer builder assembly 78 is provided with suitable features that enable smooth, low-friction movement along the secondary track 76. Suitable features can take many different forms, including rollers, but in the example of FIGS. 9-13 comprise a plurality of precision, low-friction guide blocks configured to mate with a corresponding cross-section of the secondary track 76.

The layer builder assembly 78 is designed for high-precision guided movement along the secondary track 76. Those of skill in the art will envision numerous alternative methods/mechanisms to achieve high-precision guided movement, including but not limited to lead screws, hydraulics, pneumatics, cable controls, and the like. In the illustrated examples, however, high-precision guided movement is achieved with the use of rack gears positioned alongside, or otherwise fixed relative to, the secondary track 76. One rack gear is fitted to each side of the secondary track 76. At least one pinion gear 82 is operatively engaged with each rack gear of the secondary track 76, and a drive motor 84 is operatively connected to each pinion gear 82. The pinion gears 82 are driven through the respective drive motors 84. By selectively activating the drive motors 84, the layer builder assembly 78 self-propels along the secondary track 76 with high-precision guided movement.

The layer builder assembly 78 includes three cooperating modules: a printer module, a sand dispenser module, and a drying module. These three modules are arranged in a nested configuration, with the printer module located in the longitudinal center of the assembly 78, the sand dispenser module flanking both forward and rearward faces of the printer module, and the drying module in turn flanking the sand dispenser module on both ends. As will be described in greater detail below, with each pass of the layer builder assembly 78 over the build box 34, the sand dispenser module dispenses a thin layer of sand onto the build plate 40, followed by the printer module 86 which applies a computer-controlled spray pattern of liquid binder agent, and followed finally by the drying module which energetically cures the applied binder agent. This sequence of activity will be described more fully after each of the individual modules have been explained.

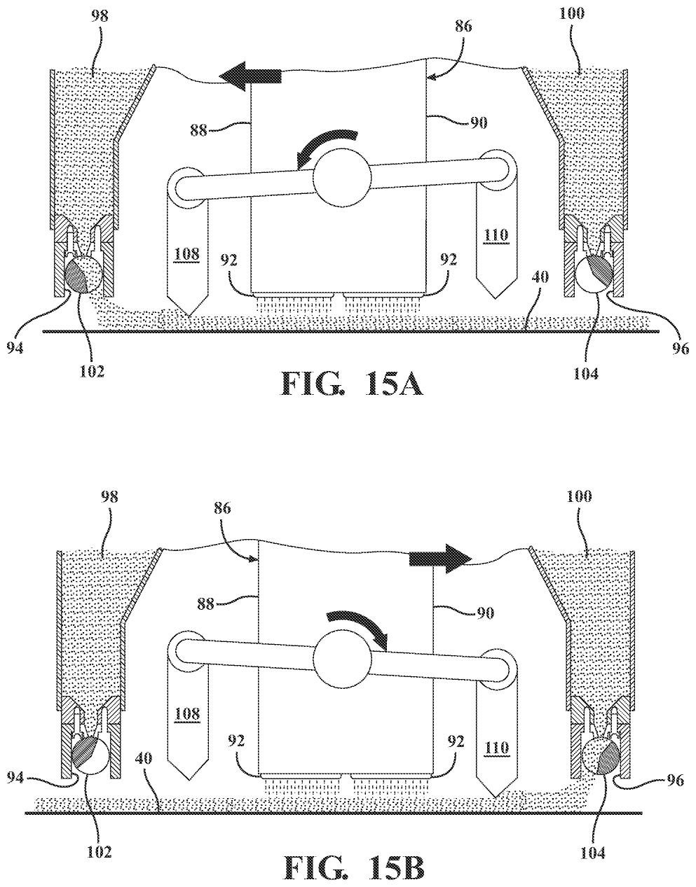

The printer module is generally indicated at 86 in FIGS. 1, 2 and 9-15B. The printer module 86 may be integrated into a carriage that also includes the aforementioned drive motors 84 mounted on opposite sides. The printer module 86 has a forward face 88 and a longitudinally spaced rearward face 90. These faces 88, 90 are only labeled in FIGS. 15A & 15B, but represent those sides of the printer module 86 that lead when the layer builder assembly 78 is moving in the forward and rearward directions. That is to say, the bi-directional nature of the layer builder assembly 78 means that it actively builds mold/core layers when moving in both the forward and rearward directions within the machine 30. Although the assignment of forward and rear directions is arbitrary, for purposes of discussion the forward face 88 will be that side of the printer module 86 facing toward the service end of the secondary track 76, whereas the rearward face 90 will be that side of the printer module 86 facing toward the load end of the primary guide track 32.

The printer module 86 includes an array of printheads 92 configured to print a binder agent on sand according to a predetermined pattern representing the mold and/or core to be formed. Each printhead 92 is preferably of the inkjet type, being independently computer controlled to apply, or spray, the binder in a predetermined pattern onto a freshly deposited layer of sand. In one embodiment, the printheads 92 are precision piezoelectric devices. Each printhead 92 would thus be expected to be served by a dedicated driver circuit. It is anticipated that one or more thermoelectric coolers may be incorporated into the layer builder assembly 78 to assist in cooling areas of computer control and other types of heat generating circuitry. While the construct of this invention could enable use of a variety of different kinds and compositions of binder agents, the type most preferred is the type described in the Applicant's own US 2021/0370388, the entire disclosure of which is incorporated by reference and relied upon.

In most cases, the array of printheads 92 will be generally centered between the forward 88 and rearward 90 faces. Referring to FIG. 11, the array may take the form of a first plurality of printheads 92 arranged end-to-end, and a second plurality of printheads 92 also arranged end-to-end. The second plurality of printheads 92 are offset laterally relative to the first plurality of printheads 92 such that abutting ends of the second plurality of printheads 92 do not longitudinally align with abutting ends of the first plurality of printheads 92. In the illustrated embodiment the printer module 86 includes, in total, eight individual printheads 92 arranged in two off-set rows. The two rows of printheads 92 are centered on a center line of the build box 34, and preferably span the entire width of the build plate 40 so as to enable printing of the binder agent at any location over sand layers applied to the build plate 40. As discussed above, the layer builder assembly 78 is configured for printing in both forward and rearward directions. Thus, the printheads 92 are arranged in a mirror configuration.

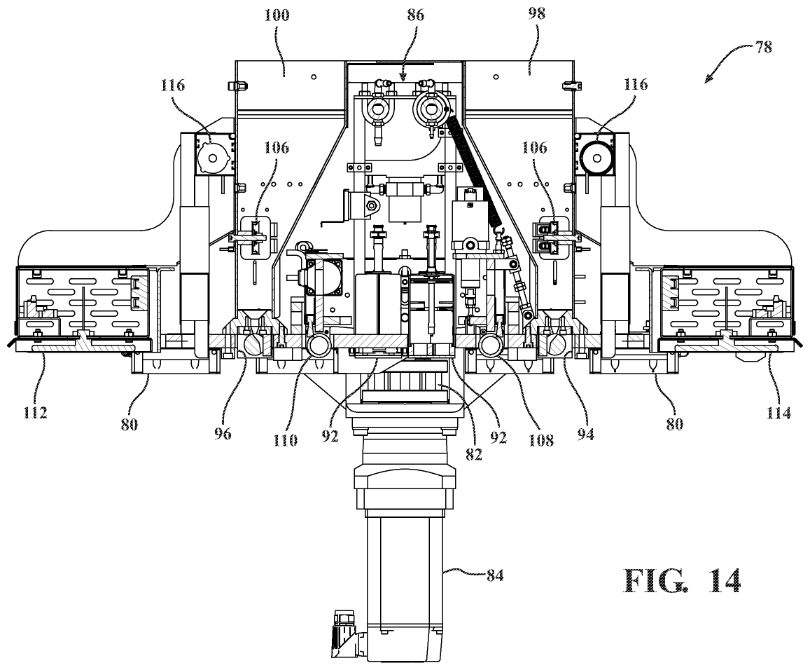

Turning now to the sand dispenser module of the layer builder assembly 78, reference will be made mostly to FIGS. 14-19. The sand dispenser module includes a forward sand dispensing nozzle 94 and a rearward sand dispensing nozzle 96. The forward 94 and rearward 96 sand dispensers respectively are located on opposite sides of the array of printheads 92, as perhaps best shown in FIGS. 15A and 15B. That is to say, the forward sand dispensing nozzle 94 is longitudinally spaced from the forward face 88 of the printer module 86, whereas the rearward sand dispensing nozzle 96 longitudinally spaced from the rearward face 90 of the printer module 86.

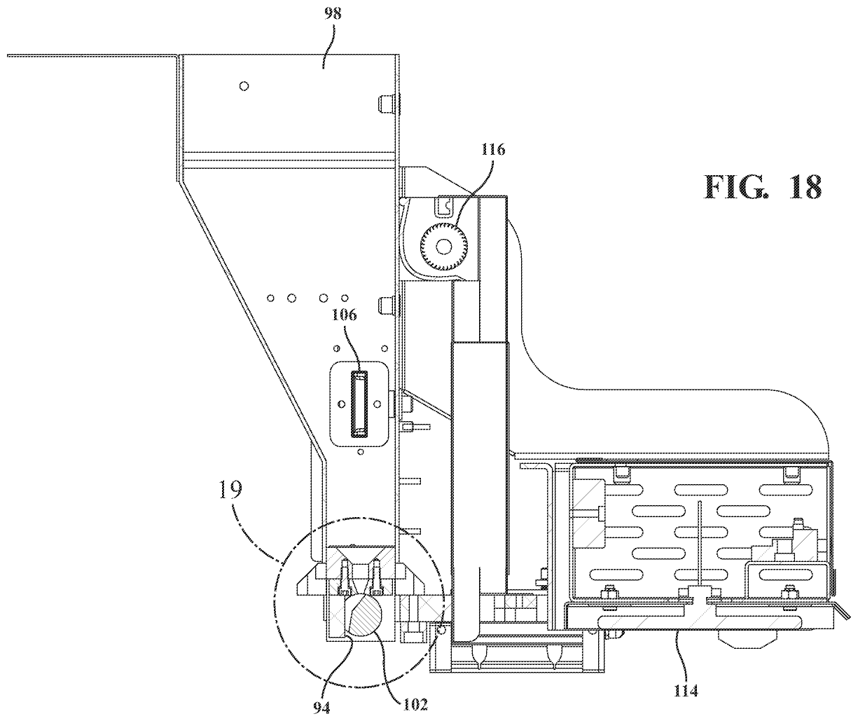

Each sand dispensing nozzle 94, 96 is served by a dedicated sand hopper integrated into the layer builder assembly 78. Thus, a forward mobile hopper 98 is operatively connected to the forward sand dispensing nozzle 94 for feeding sand thereto. Likewise, a rearward mobile hopper 100 is operatively connected to the rearward sand dispensing nozzle 96 for feeding sand to it. Each mobile hopper 98, 100 defines an interior volume for containing the sand or other suitable layer building material. A cross-section through the forward mobile hopper 98 is shown in FIG. 18.

Valves are provided to control the flow of sand to each dispensing nozzle 94, 96. Again referring to FIGS. 15A and 15B, a forward sand valve 102 is disposed between the forward mobile hopper 98 and the forward sand dispensing nozzle 94. The forward sand valve 102 controls the flow of sand from the forward mobile hopper 98 to the forward sand dispensing nozzle 94. Similarly, a rearward sand valve 104 is operatively disposed between the rearward mobile hopper 100 and the rearward sand dispensing nozzle 96. The rearward sand valve 104 controls the flow of sand from the rearward mobile hopper 100 to the rearward sand dispensing nozzle 96.

In the illustrated embodiment, each sand valve 102, 104 is shown having a shaft configured with a double bevel structure to maximize strength. The shaft runs substantially the length of the respective dispensing nozzle 94, 96, and may be variably rotated between open and closed positions to manage the flow rate of sand into, and through, the dispensing nozzles 94, 96. The sand valves 102, 104 may include one or more position sensors (not shown) to assist with the control function.

FIGS. 15A and 15B offer graphical depictions of the operation of these sand valves 102, 104. FIG. 15A portrays forward movement toward the left, as if viewed from the perspective of FIG. 1. As the layer builder assembly 78 moves in the forward direction, the forward sand valve 102 is rotated to an open condition allowing sand carried in the forward mobile hopper 98 to flow under the influence of gravity through the forward sand dispensing nozzle 94 where it is more or less evenly distributed over the build plate 40. Meanwhile, the rearward sand valve 104 is closed; no sand is emitted through the rearward sand dispensing nozzle 96.

FIG. 15B portrays rearward movement toward the right. As the layer builder assembly 78 moves in the rearward direction, the rearward sand valve 104 is rotated to an open condition allowing sand carried in the rearward mobile hopper 100 to flow under the influence of gravity through the rearward sand dispensing nozzle 98 where it is more or less evenly distributed over the build plate 40. The forward sand valve 102 is closed; no sand is emitted through the forward sand dispensing nozzle 94 during rearward movement of the layer builder assembly 78.

Each mobile hopper 98, 100 may include a heating element 106 for transferring heat energy into the sand contained therein. FIG. 18 offers a cross-sectional view through the rearward mobile hopper 100, the forward mobile hopper 98 being substantially identical. In this view, the heating element 106 can be seen inside the rearward mobile hopper 100. Many alternative deployments of a heating element 106 in connection with the mobile hoppers 98, 100 are certainly possible.

The sand dispenser module of the layer builder assembly 78 further includes sand leveling features to provide highly accurate control over the height of the layer of sand being dispensed, prior to application of the binder by the printheads 92. The sand leveling features can take a variety of forms. Shown in the example of FIGS. 15A and 15B are scraper-like strike-off bars. A forward sand leveler 108 is disposed between the forward sand dispensing nozzle 94 and the printer module 86, and in mirror fashion a rearward sand leveler 110 is disposed between the rearward sand dispensing nozzle 96 and the printer module 86. The forward 108 and the rearward 110 sand levelers may be independently controlled and operated. But in the illustrated example the levelers 108, 110 are operatively connected via a teeter-totter like mechanism for inverse reciprocating motion. In this construction, as the forward sand leveler 108 is lowered into scraping position the rearward sand leveler 110 is raised out the way, and vise-versa. The height of the scraping edge of each strike-off bar is controlled by a servo motor or other suitable device, thus establishing a uniform thickness of sand layer upon the build plate 40. In some embodiments, the strike-off bars can ride along the rim of each end of the sidewalls 36, using that rim feature as a control surface. Excess sand plowed to the end of the build plate 40 falls into the overflow chamber 42. Struck-off sand captured in the overflow chambers can be reclaimed.

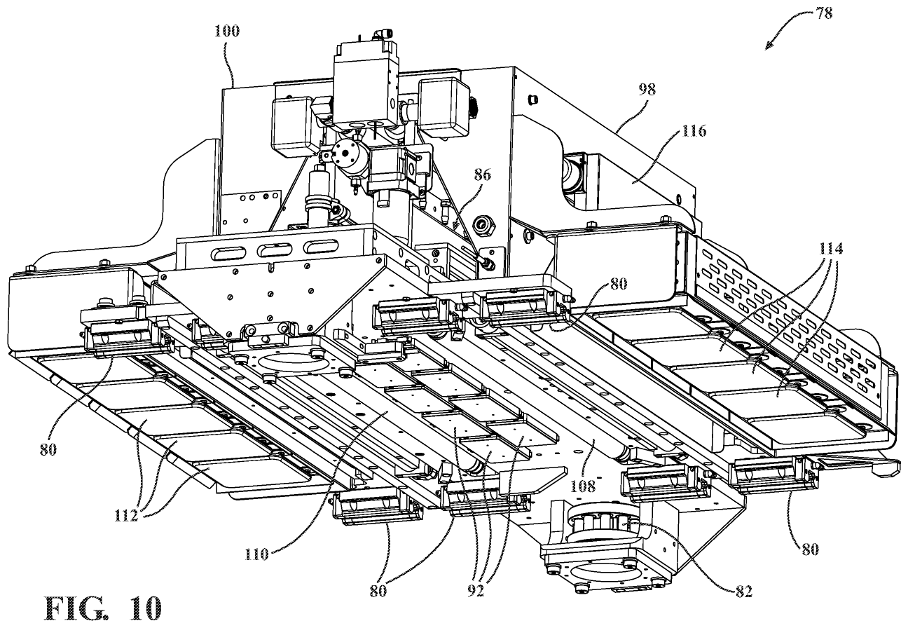

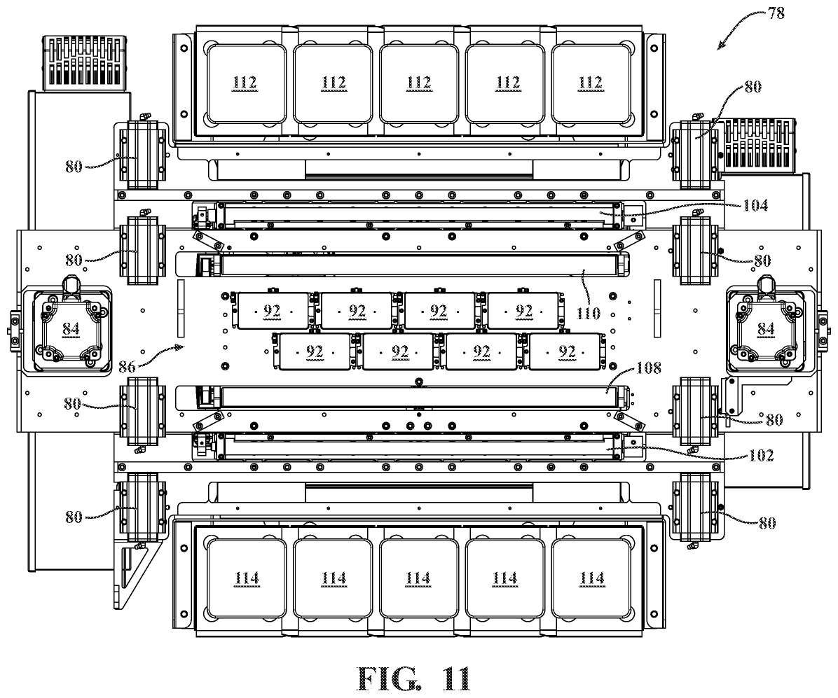

In the example of FIGS. 10, 11 and 14, the sand leveling features are shown in the alternative forms of counter-rotating strike off rollers. It is contemplated that the strike off rollers are controllably rocked in a direction opposite of the direction of movement of the layer builder assembly 78, similar to the rocking motion of the strike-off bars 108, 110 of FIGS. 15A and 15B. In one embodiment, the pivoting assembly is tipped forward in the direction the layer builder assembly 78 is moving, lowering the nip of the counter-rotating strike off roller on the leading (relative to motion) face of the printer module 86 into contact with the top surface of the layer of sand.

Turning now to the drying module of the layer builder assembly 78, reference will be made mostly to FIGS. 10, 11, 14 and 18. As stated previously, the novel construct of the machine 30 enables use of a variety of different kinds and compositions of binder agents. Different types of binder agents may require different methods to cure, or harden, the binder and thereby adhere the sand into the desired mold or core shape. Some types of binder agents may require microwave energy, others may require ultraviolet light, still others may require heat or simply time, to name but a few of the many options. The drying module travels with the print head module 86 and the sand dispenser module to initiate curing, or setting, of the binder agent on the fly. In this manner, before the layer builder assembly 78 begins to form a new layer of the sand mold or core, the drying process for the binder agent in the previously laid layer has already begun and, in ideal circumstances, will be well underway but not fully cured so that the next successive sand layer will be able to readily adhere.

The binder type most preferred with this present invention is that environmentally friendly type described in the Applicant's own US 2021/0370388, in which the binder agent is comprised of starch nanoparticles, such as corn starch or corn syrup, carried in a water-based solvent. A binder agent of this type is cured by driving off the solvent and hardening the binder using a combination of heat and vapor extraction.

The machine 30 may be outfitted with a comprehensive, strategic heating system configured to improve drying efficiency. This strategic heating system will include the aforementioned devices directed at heating the sand, knowing that heat is an important mechanism to cure a starch nanoparticle-based binder agent carried in a water-based solvent. Such aforementioned devices include the heating element 50 integrated into the build plate 40, and the heating elements 106 stationed in the mobile hoppers 98, 100.

To further help advance the drying process of a binder agent comprised of corn starch or corn syrup carried in a water-based solvent, the drying module of the layer builder assembly 78 may include forward 112 and rearward 114 heater banks. The forward heater bank 112 is longitudinally spaced from the forward sand dispensing nozzle 94, whereas the rearward heater bank 114 is longitudinally spaced from the rearward sand dispensing nozzle 96. However, in the case of these heater banks, the forward and rearward designations can be confusing in that the drying module function must commence after the binder is printed on the sand. Therefore, the forward heater bank 112 is on the opposite side of the printheads 92 from the forward sand dispensing nozzle 94, and conversely the rearward heater bank 114 is on the opposite side of the printheads 92 from the rearward sand dispensing nozzle 96.

Each heater bank 112, 114 may be composed of one or more arrays of heating elements, perhaps best seen in FIGS. 10 and 11. In one embodiment, the heating elements may be infrared or microwave heating elements, but other types of heating elements may be used. In one aspect of the present invention, the arrays of heating elements are always “on” or in heat emitting state during a printing, or mold making, operation. An advantage to always “on” heating elements is that with every back-and-forth pass of the layer builder assembly 78 over the build plate 40, previously established binder printed on underlying layers of sand are repeatedly energized to the extent that the heat or microwave energy is able to penetrate the built-up layers.

In FIGS. 10 and 11, the heating elements are shown set in rectilinear order with respect to the longitudinal direction, and relatively closely spaced apart from one another. In other contemplated embodiments, the heating elements could be angled with respect to the direction of movement of the layer builder assembly 78. In any event, the orientation of the heating elements should be configured to optimize uniform heating of the underlying sand layers.

The drying module of the layer builder assembly 78 may further include one or more cross flow blowers 116. The one or more crossflow blowers 116 are strategically located to help remove water vapor created during the drying module process and promote binder curing by forced convection. In the illustrated embodiment, the layer builder assembly 78 is fitted with two crossflow blowers 116, one adjacent each of the forward 112 and rearward 114 heater banks. Both crossflow blowers 116 could be controlled to operate concurrently, in always “on” mode, to displace water vapors generated during the printing process away from the build box 34. In another embodiment, only the trailing crossflow blower 116 is operating during the print process. The one or more crossflow blowers 116 may be driven by suitable motors that enable the fan speeds to be varied to meet different ventilation needs.

In operation, an empty build box 34 is moved like a boxcar from the load end of the primary guide track 32 to the build end. The lift unit 54 activates to raise the build plate 40 to its highest level within the sidewalls 36, as nearly level with the open top thereof. The layer builder assembly 78 is also moved by its drive motors 84 along the secondary track 76 on the print section thereof, where the assembly 78 passes over the empty build plate 40 like a gantry.

Starting at one end of the build plate 40 and moving longitudinally in either the forward or rearward direction, the layer builder assembly 78 passes over the build plate 40 while depositing a thin layer of sand, or other suitable granular build material. The transiting layer builder assembly 78 sprays the binder agent in a predetermined pattern onto the freshly deposited and leveled sand layer to make the portion of the mold or core as that portion exists at the corresponding horizontal layer or strata of the completed 3-dimenional mold or core.

Once the layer builder assembly 78 has completed a pass over the build plate 40, the lift unit 54 incrementally lowers the build plate 40 a measurement equal to the depth of the next desired sand layer. The configuration of the layer builder assembly 78 allows for each layer of sand to be applied and printed while traveling in the forward and rearward longitudinal directions. After many such back-and-forth passes, a 3-dimenional mold or core is eventually fully formed. Thus, a completed 3-dimenional mold or core is formed incrementally, by an accumulation of horizontal layers, utilizing both forward and rearward passes of the layer builder assembly 78 over the build plate 40. For instance, when the layer builder assembly 78 is being moved in a direction toward the left as in the example of FIG. 15A, the forward sand dispensing nozzle 94 lays down a layer of sand and, after leveling, the printheads 92 spray binder in the predetermined pattern. The trailing forward radiant heater bank 112 (not visible in FIG. 15A) initiates drying module of the freshly laid binder agent. When the layer builder assembly 78 is being moved in a direction toward the right as in FIG. 15B, the rearward sand dispensing nozzle 96 lays down a layer of sand and, after leveling, the trailing printheads 92 spray binder in the predetermined pattern. The rearward radiant heater bank 114 initiates drying module of the freshly laid binder agent. In this manner, the bi-directional functionality of the layer builder assembly 78 enables rapid construction of sand molds, cores and/or 3-dimensional shapes according to the methods of this invention.

A ventilation system, generally indicated at 118 in FIGS. 1 and 2, may be stationed over the print section of the secondary track 76. The ventilation system 118 is employed to energetically remove moisture driven off from the binder as it cures on deposited layers of sand. In the illustrated examples, the ventilation system 118 includes a large hood having a rectangular pyramid shape similar to exhaust hoods used in various industries. A draft fan motor supported at an upper portion of the hood is configured to generate a forceful exhaust flow of ambient air from around the bi-directional layer builder assembly 78. Vapors displaced and agitated by the activity of the crossflow blowers 116 may be easily drawn up and away from the machine 30, thus promoting rapid curing of the binder agent.

The service section of the secondary track 76 is provided for various service operations that may be carried out on the layer builder assembly 78. In the illustrated examples, these service operations are suggested as periodic refilling of the mobile hoppers 98, 100 and periodic cleaning and/or overnight flushing of the printheads 92.

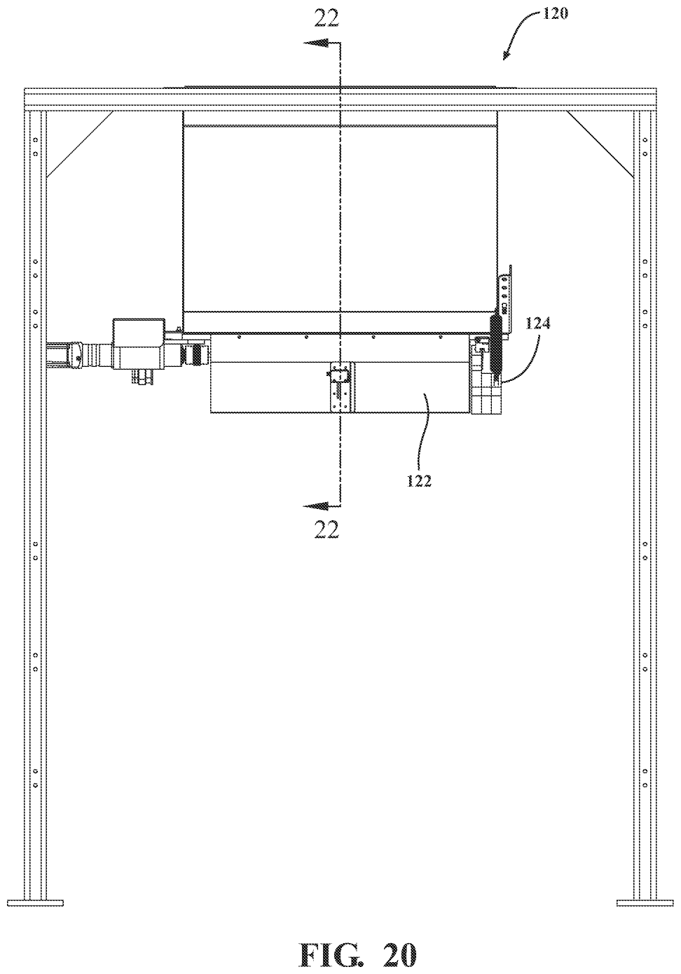

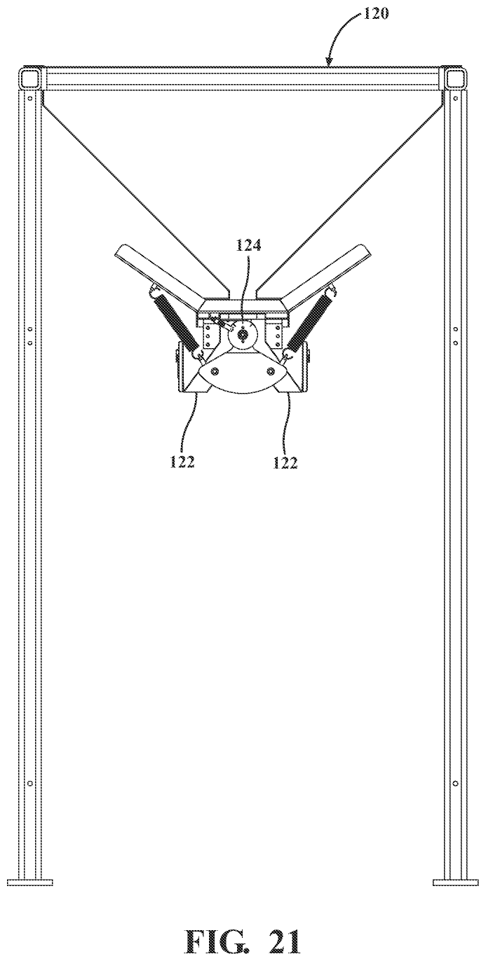

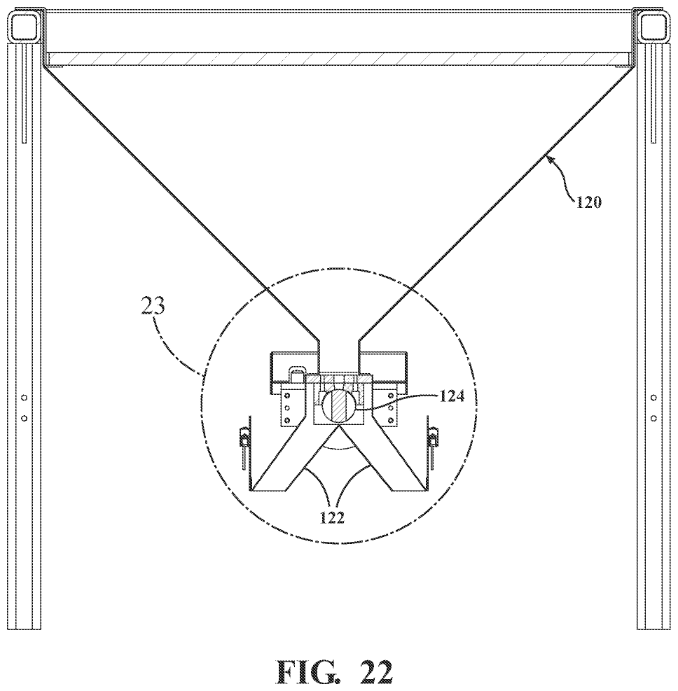

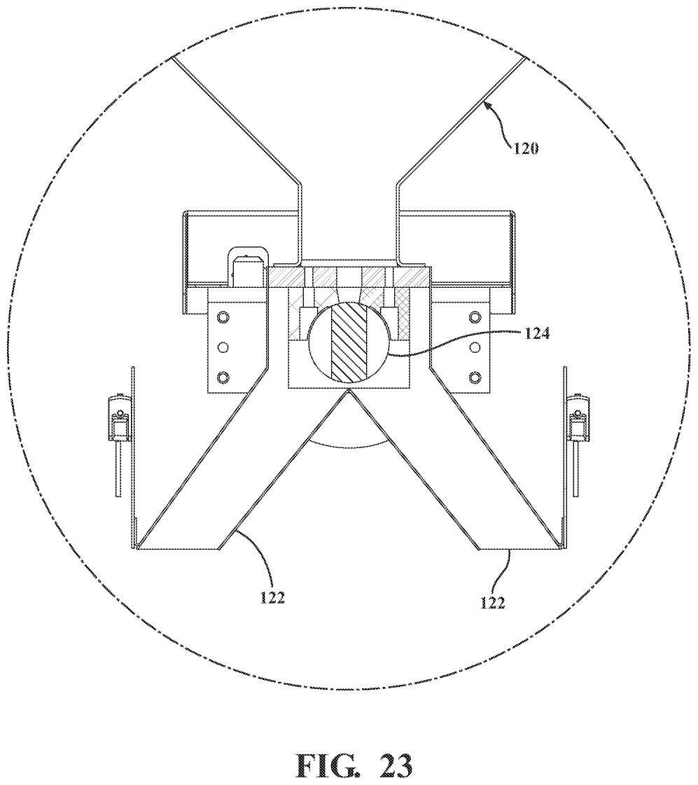

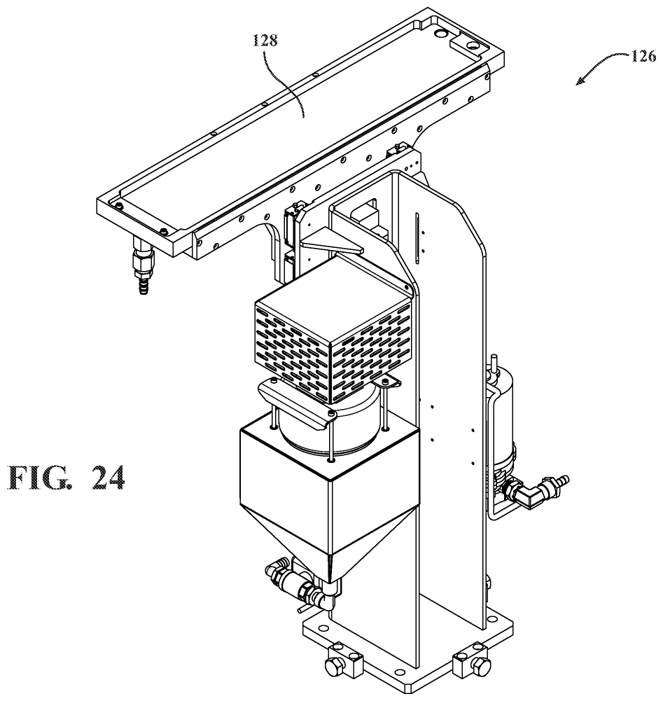

A sand filling station is generally indicated at 120 in FIGS. 1, 2 and 20-23. The sand filling station 120, which is disposed over the service section of the secondary track 76, includes a large stationary sand hopper that defines a reservoir for storing sand or other suitable layer building material. At the bottom of the hopper is a bifurcated delivery chute 122. The bifurcated delivery chute 122 has forward and rearward legs that are configured to concurrently register with the respective forward 98 and rearward 100 mobile hoppers when the layer builder assembly 78 is positioned in the service section. FIGS. 22 and 23 show a control valve 124 that is operatively disposed between the large hopper and the bifurcated delivery chute 122. The control valve 122 is toggle-like device configured to alternately admit flows of sand from the large stationary hopper, through the forward or rearward legs and into the respective forward 98 and rearward 100 mobile hoppers of the layer builder assembly 78. In this way, the forward 98 and rearward 100 mobile hoppers can be periodically topped-up with sand for building layers.

The sand filling station 120 is thus configured to refill the forward 98 and rearward 100 mobile hoppers carried on the layer builder assembly 78 as needed or as a pre-programmed operation. To refill the mobile hoppers 98, 100, the layer builder assembly 78 is moved to the end of the machine 30 that comprises the service section of the secondary track 76. Upon actuation of the control valve 124, sand within the large storage hopper flows under the influence of gravity through one side of the bifurcated chute 122 into a selected one of the mobile hoppers 98, 100. In another contemplated embodiment, the control valve 124 could be configured to admit sand through both legs of the chute 122 at the same time, thus concurrently filling both forward 98 and rearward 100 mobile hoppers.

Level sensors may be strategically added to measure the level of sand in the forward 98 and rearward 100 mobile hoppers. In one embodiment, such level sensors are laser-based sensors. When the layer builder assembly 78 is positioned at the service section of the machine 30, the sensors measure or sense the current level of sand within each of the mobile hoppers 98, 100. If the level of sand within mobile hopper 98, 100 is below a specified level, the control valve 124 is automatically actuated to refill the one or both mobile hoppers 98, 100.

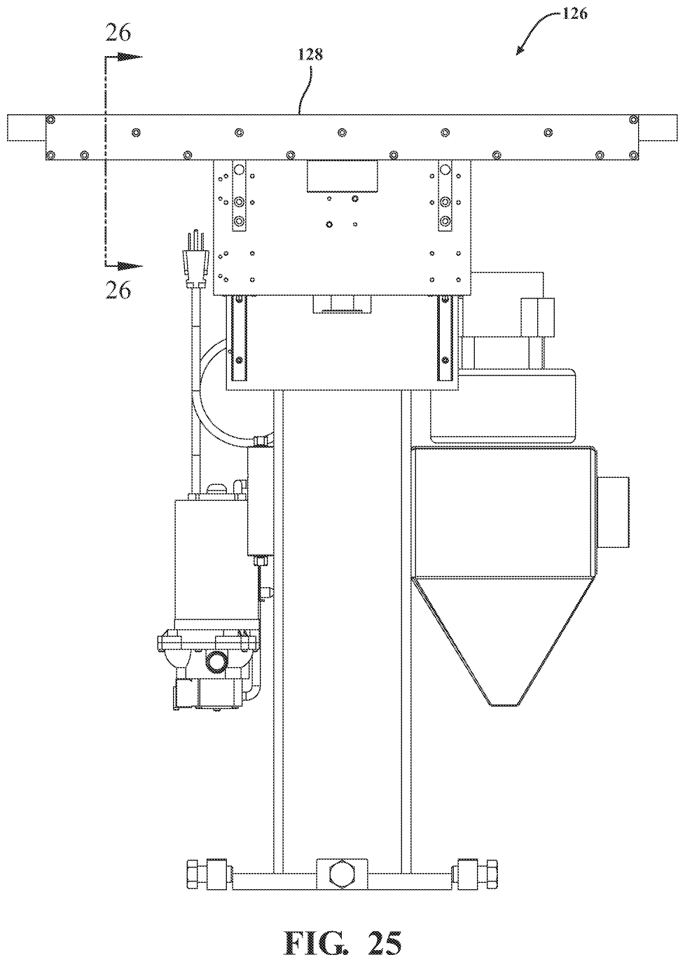

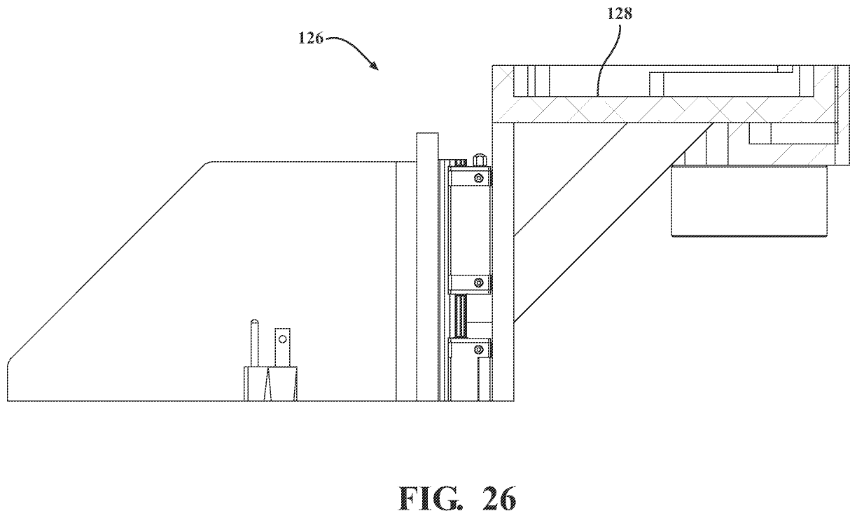

A cleaning station, generally indicated at 126, may also be operatively associated with the service section of the secondary track 76. The cleaning station 126, which is best seen in FIGS. 2 and 24-26, is provided for cleaning and/or flushing the printheads 92 either periodically throughout a service shift or during longer periods of non-use such as overnight. The cleaning station 126 is particularly useful to maintain functionality of the printheads 92 and to prevent them from drying out during periods of non-use. In the illustrated embodiment, the cleaning station 126 is located under the large stationary hopper of the sand filling station 120. The cleaning station 126 can take any convenient form. In one embodiment, the cleaning station 126 includes a solution well in the form of a soaker pan 128. The soaker pan 128 is configured to immerse the printheads 92 in a shallow bath of liquid cleaning agent.

The soaker pan 128 may include a bath inlet at one end and a bath outlet at an opposite end to enable a circulating flow of the liquid cleaning agent across the immersed printheads 92 to remove sand and other contaminants. It may be desirable to locate the outlet at a higher elevation than the inlet. The difference in elevation between inlet and outlet will naturally establish an operating depth of liquid in the soaker pan 128, with the upper outlet remaining open and serving as an active overflow drain.

In one embodiment, the soaker pan 128 is raised until the printheads 92 are immersed in the solution. The solution may be heated to help soften and loosen any debris or contaminants adhered to the printheads 92. In one embodiment, the heated solution is pumped into the soaker pan 128 by a fluid pump. Between cleaning processes or at regular cleaning intervals, the cleaning solution in the soaker pan 128 can be drained for cleaning and to remove any collected contaminants.

One edge of the soaker pan 128 can be configured as a vacuum knife. After the printheads 92 have been soaked within the cleaning solution for a predetermined time period, the soaker pan 128 is slightly lowered and the layer builder assembly 78 is moved longitudinally relative to the vacuum knife but without contacting the vacuum knife so that loosened debris, other contaminants, and excess solution may be sucked from the printheads 92. In such an arrangement, the cleaning station 126 may further include a vacuum pump or blower that draws a heavy suction through a slot directly adjacent the vacuum knife. The delicate orifices of the printheads 92 are protected by limiting direct contact to the cleaning solution only.

As previously mentioned, the build box 34 is configured to ride upon the primary guide track 32 like a trolley, shuttling between the load end and the build end. An empty build box 34 is shuttled from the load end to the build end, where a sand mold or core is build therein layer-by-layer. The build box 34 with completed mold or core is eventually shuttled back to the load end when a worker takes the build box 34 and completed mold or core to another location for further processing to removed loose sand and prepare the mold or core for a metal casting operation.

In operation, generally, the build box 34 is moved along the primary guide track 32 to the build end. The lift unit 54 is activated to rise into engagement with the build plate 40 of the build box 34 and lift the built plate 40 to a position at or near the upper rim of the build box 34. Next, the layer builder assembly 78 is controlled, through pre-programmed instructions, to move toward the build box 34, where a thin layer of sand is deposited over the entire build plate 40 of the build box 34. After the thin layer of sand is deposited, a binder is strategically sprayed onto the sand to achieve the desired shape of the mold cavity and/or gate system. Leveling bars 108, 110 or rollers carried on the layer builder assembly 78 precisely control the thickness of each sand layer deposited on the build plate 40. The deposited sand is coated with a spray-on binder using precision piezoelectric printheads 92 based on the desired shape of the object being built. Heater banks 112, 114 also carried on the layer builder assembly 78 help initiate rapid curing of the binder to solidify the deposited sand in the built-up shape of the mode or core. As each layer of sand layer is completed with desired binder applications, the lift unit 54 lowers the build plate 40 a distance equal to the thickness of the deposited sand layer, in preparation for a new layer of sand to be deposited.

In this manner, layers of sand are sequentially deposited until the completed mold or core has been fully formed. At predetermined intervals throughout the sand layering process, the layer builder assembly 78 may be directed to a service section where its small on-board sand reservoirs 98, 100 are refilled by the large sand refill storage hopper 120. Also at predetermined intervals, the layer builder assembly 78 may be directed to a service section where its printheads 92 receive cleaning treatment at the cleaning station 126.

When the completed mold has been fully formed, the lift unit 54 disengages and retracts from the build box 34. The build box 34 translates along the primary guide track 32 to the load end, where it is removed from the machine and loaded onto a transfer cart, to be transferred to a de-sanding station. After processing at a de-sanding station, the mold or core is finally ready for use in a metal casting operation. The empty build box 34 is returned to the load end of the primary guide track 32 to repeat the cycle of building a new sand mold or core.

Operation of the volumetric builder machine 30 is controlled via any suitable computer control device or module. An operator may enter control commands via a touchscreen panel 130 as shown in FIG. 1. For instance, using the touchscreen panel 130, a user may select a mold to be constructed from one or more predefined models of molds and select or enter related parameters of the models.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. A machine for making sand-casting molds, cores and/or 3-dimensional shapes in bi-directionally printed layers, said machine comprising:
a primary guide track extending longitudinally between opposite ends, one of said ends comprising a build end,
a build box supported on said primary guide track for shuttling movement toward and away from said build end, said build box having sidewalls forming an interior space, said interior space defining a bottom and an open top, a horizontal build plate disposed inside of said sidewalls for vertical movement between said open top and said bottom,
a lift unit configured to vertically displace said build plate within said sidewalls,
a secondary track extending parallel to and longitudinally overlapping said primary guide track, a length of said secondary track comprising a print section, said print section overlying said build end of said primary guide track,
a bi-directional layer builder assembly supported on said secondary track for back-and-forth movement within said print section, said layer builder assembly having a printer module, said printer module having a forward face and a longitudinally spaced rearward face, said printer module including a printer array configured to print a binder agent on sand according to a predetermined pattern representing the mold and/or core to be formed, said layer builder assembly having a forward sand dispensing nozzle longitudinally spaced from said forward face of said printer module and a rearward sand dispensing nozzle longitudinally spaced from said rearward face of said printer module, a forward sand leveler disposed between said forward sand dispensing nozzle and said printer module, a rearward sand leveler disposed between said rearward sand dispensing nozzle and said printer module, a forward heater bank longitudinally spaced from said forward sand dispensing nozzle, and a rearward heater bank longitudinally spaced from said rearward sand dispensing nozzle.

2. The machine of claim 1 wherein said bi-directional layer builder assembly includes a forward mobile hopper operatively connected to said forward sand dispensing nozzle for feeding sand thereto, and a rearward mobile hopper operatively connected to said rearward sand dispensing nozzle for feeding sand thereto.

3. The machine of claim 2 wherein said bi-directional layer builder assembly includes a forward sand valve disposed between said forward mobile hopper and said forward sand dispensing nozzle for controlling the flow of sand from said forward mobile hopper to said forward sand dispensing nozzle, a rearward sand valve disposed between said rearward mobile hopper and said rearward sand dispensing nozzle for controlling the flow of sand from said rearward mobile hopper to said rearward sand dispensing nozzle.

4. The machine of claim 2 wherein said forward mobile hopper includes a heating element, and said rearward mobile hopper includes a heating element.

5. The machine of claim 1 wherein said build plate of said build box has a generally rectangular perimeter fitted with a dynamic perimeter seal in pressing engagement with said sidewalls, said dynamic perimeter seal including a flexible element disposed in a rigid carrier.

6. The machine of claim 1 wherein said build plate of said build box includes at least one heating element.

7. The machine of claim 1 wherein said forward and said rearward sand levelers are operatively connected to one another for inverse reciprocating motion wherein as said forward sand leveler is raised said rearward sand leveler is lowered and as said forward sand leveler is lowered said rearward sand leveler is raised.

8. The machine of claim 1 wherein said forward and rearward sand levelers each comprises at least one of a strike-off roller and a strike-off bar.

9. The machine of claim 1 wherein said secondary track has a service section extending longitudinally away from said print section and away from said primary guide track, further including a sand filling station disposed over said service section of said secondary track, said sand filling station having a stationary sand hopper, a bifurcated delivery chute connected to said stationary sand hopper, said bifurcated delivery chute having forward and rearward legs, said forward and rearward legs configured to register the respective said forward and rearward mobile hoppers when said layer builder assembly is at said service section.

10. The machine of claim 9 wherein said sand filling station includes a control valve operatively disposed between said stationary sand hopper and said bifurcated delivery chute, said control valve configured to admit flows of sand from said stationary hopper to each of said forward and rearward legs.

11. The machine of claim 1 wherein said secondary track has a service section extending longitudinally away from said print section and away from said primary guide track, further including a cleaning station operatively associated with said service section of said secondary track, said cleaning station having a soaker pan configured to clean and/or flush said first and second plurality of printheads with a liquid cleaning agent.

12. The machine of claim 1 further including a ventilation system stationed over said print section of said secondary track, said ventilation system including a hood overlying said bi-directional layer builder assembly when said layer builder assembly is at said print section, a draft fan motor supported on said hood and configured to generate a forceful exhaust flow of ambient air from around said bi-directional layer builder assembly.

13. A volumetric builder machine for making sand-casting molds, cores and/or 3-dimensional shapes in bi-directionally printed layers, said machine comprising:
a primary guide track extending longitudinally between opposite ends, one of said ends comprising a build end,
a build box supported on said primary guide track for shuttling movement toward and away from said build end, said build box having sidewalls forming an interior space, said interior space defining a bottom and an open top, a horizontal build plate disposed inside of said sidewalls for vertical movement between said open top and said bottom,
a lift unit configured to vertically displace said build plate within said sidewalls,
a secondary track extending parallel to and longitudinally overlapping said primary guide track, a length of said secondary track comprising a print section, said print section overlying said build end of said primary guide track, said secondary track having a service section extending longitudinally away from said print section and away from said primary guide track,
a bi-directional layer builder assembly supported on said secondary track for back-and-forth movement within said print section, said layer builder assembly having a printer module, said printer module having a forward face and a longitudinally spaced rearward face, said printer module including a printer array configured to print a binder agent on sand according to a predetermined pattern representing the mold and/or core to be formed, said printer array comprising a first plurality of printheads arranged end-to-end, said printer array comprising a second plurality of printheads arranged end-to-end, said second plurality of printheads being offset laterally relative to said first plurality of printheads such that abutting ends of said second plurality of printheads do not longitudinally align with abutting ends of said first plurality of printheads, each said printhead in said first and second plurality of printheads being configured as an inkjet printhead,
said layer builder assembly including a forward mobile hopper operatively connected to said forward sand dispensing nozzle for feeding sand thereto, and a rearward mobile hopper operatively connected to said rearward sand dispensing nozzle for feeding sand thereto,
said layer builder assembly having a forward sand dispensing nozzle longitudinally spaced from said forward face of said printer module and a rearward sand dispensing nozzle longitudinally spaced from said rearward face of said printer module, a forward sand leveler disposed between said forward sand dispensing nozzle and said printer module, a rearward sand leveler disposed between said rearward sand dispensing nozzle and said printer module, a forward heater bank longitudinally spaced from said forward sand dispensing nozzle, a rearward heater bank longitudinally spaced from said rearward sand dispensing nozzle, and
a ventilation system stationed over said print section of said secondary track, said ventilation system including a hood overlying said bi-directional layer builder assembly when said layer builder assembly is at said print section, a draft fan motor supported on said hood and configured to generate a forceful exhaust flow of ambient air from around said bi-directional layer builder assembly.

14. The machine of claim 13 wherein said bi-directional layer builder assembly includes a forward sand valve disposed between said forward mobile hopper and said forward sand dispensing nozzle for controlling the flow of sand from said forward mobile hopper to said forward sand dispensing nozzle, a rearward sand valve disposed between said rearward mobile hopper and said rearward sand dispensing nozzle for controlling the flow of sand from said rearward mobile hopper to said rearward sand dispensing nozzle.

15. The machine of claim 13 wherein said forward mobile hopper includes a heating element, and said rearward mobile hopper includes a heating element.

16. The machine of claim 13 wherein said build plate of said build box has a generally rectangular perimeter fitted with a dynamic perimeter seal in pressing engagement with said sidewalls, said dynamic perimeter seal including a flexible element disposed in a rigid carrier, said build plate of said build box including at least one heating element.

17. The machine of claim 13 wherein said forward and said rearward sand levelers are operatively connected to one another for inverse reciprocating motion wherein as said forward sand leveler is raised said rearward sand leveler is lowered and as said forward sand leveler is lowered said rearward sand leveler is raised.

18. The machine of claim 13 wherein said secondary track has a service section extending longitudinally away from said print section and away from said primary guide track, further including a sand filling station disposed over said service section of said secondary track, said sand filling station having a stationary sand hopper, a bifurcated delivery chute connected to said stationary sand hopper, said bifurcated delivery chute having forward and rearward legs, said forward and rearward legs configured to register the respective said forward and rearward mobile hoppers when said layer builder assembly is at said service section.

19. The machine of claim 13 wherein said secondary track has a service section extending longitudinally away from said print section and away from said primary guide track, further including a cleaning station operatively associated with said service section of said secondary track, said cleaning station having a soaker pan configured to clean and/or flush said first and second plurality of printheads with a liquid cleaning agent.

20. A volumetric builder machine for making sand-casting molds, cores and/or 3-dimensional shapes in bi-directionally printed layers, said machine comprising:
a primary guide track extending longitudinally between opposite ends, one of said ends comprising a load end and the other of said ends comprising a build end, said primary guide track comprising a pair of spaced-apart rails,
a build box supported on said primary guide track for shuttling movement between said load and build ends, said build box including wheels adapted to engage said rails of said primary guide track, said build box having sidewalls forming a generally rectangular interior space, said interior space defining a bottom and an open top, a horizontal build plate disposed inside of said sidewalls for vertical movement between said open top and said bottom, said build plate having a generally rectangular perimeter fitted with a dynamic perimeter seal in pressing engagement with said sidewalls, said dynamic perimeter seal including a flexible element disposed in a rigid carrier, said dynamic perimeter seal including a plurality of springs pressing against said rigid carrier to urge said flexible element into engagement with said vertical sidewalls, a said build plate including at least one heating element,
a lift unit disposed below said build end of said primary guide track, said lift unit including a table moveable vertically relative to said primary guide track, said table being selectively engaged with said build plate of said build box to vertically displace said build plate within said sidewalls,
a secondary track extending parallel to and longitudinally overlapping said primary guide track, a length of said secondary track comprising a print section, said print section overlying said build end of said primary guide track, said secondary track having a service section extending longitudinally away from said print section and away from said primary guide track, said secondary track including at least one longitudinally extending rack gear,
a bi-directional layer builder assembly supported on said secondary track for back-and-forth movement between said print section and said service section, said layer builder assembly including at least one pinion gear operatively engaged with said rack gear of said secondary track, a drive motor operatively connected to said pinion gear, said layer builder assembly having a printer module, said printer module having a forward face and a longitudinally spaced rearward face, said printer module including a printer array configured to print a binder agent on sand according to a predetermined pattern representing the mold and/or core to be formed, said printer array generally centered between said forward and rearward faces, said printer array comprising a first plurality of printheads arranged end-to-end, said printer array comprising a second plurality of printheads arranged end-to-end, said second plurality of printheads being offset laterally relative to said first plurality of printheads such that abutting ends of said second plurality of printheads do not longitudinally align with abutting ends of said first plurality of printheads, each said printhead in said first and second plurality of printheads being configured as an inkjet printhead, said layer builder assembly having a forward sand dispensing nozzle longitudinally spaced from said forward face of said printer module, a forward mobile hopper operatively connected to said forward sand dispensing nozzle for feeding sand thereto, a forward sand valve disposed between said forward mobile hopper and said forward sand dispensing nozzle for controlling the flow of sand from said forward mobile hopper to said forward sand dispensing nozzle, said forward mobile hopper including a heating element, said layer builder assembly having a rearward sand dispensing nozzle longitudinally spaced from said rearward face of said printer module, a rearward mobile hopper operatively connected to said rearward sand dispensing nozzle for feeding sand thereto, a rearward sand valve disposed between said rearward mobile hopper and said rearward sand dispensing nozzle for controlling the flow of sand from said rearward mobile hopper to said rearward sand dispensing nozzle, said rearward mobile hopper including a heating element, a forward sand leveler disposed between said forward sand dispensing nozzle and said printer module, a rearward sand leveler disposed between said rearward sand dispensing nozzle and said printer module, a forward heater bank longitudinally spaced from said forward sand dispensing nozzle, a rearward heater bank longitudinally spaced from said rearward sand dispensing nozzle,
a ventilation system stationed over said print section of said secondary track, said ventilation system including a hood overlying said bi-directional layer builder assembly when said layer builder assembly is at said print section, a draft fan motor configured to generate a forceful exhaust flow of ambient air from around said bi-directional layer builder assembly,
a sand filling station disposed over said service section of said secondary track, said sand filling station having a stationary sand hopper, a bifurcated delivery chute connected to said stationary sand hopper, said bifurcated delivery chute having forward and rearward legs, said forward and rearward legs configured to register the respective said forward and rearward mobile hoppers when said layer builder assembly is at said service section, a control valve operatively disposed between said stationary sand hopper and said bifurcated delivery chute,
a cleaning station operatively associated with said service section of said secondary track, said cleaning station having a soaker pan configured to immerse said first and second plurality of printheads in a liquid cleaning agent, said soaker pan having a bath inlet and a bath outlet for circulating a flow of the liquid cleaning agent across said first and second plurality of printheads.
